(19) United States
(12) Patent Application Publication
(10) Pub. No.: US 2003/0063897 A1
(43) Pub. Date: Apr. 3, 2003

(54) Information storage medium with user defined file containing reproducing information, apparatus and method therefor

(75) Inventor: Jung-Kwon Heo, Seoul (KR)

Correspondence Address: STAAS & HALSEY LLP, 700 11TH STREET, NW, SUITE 500, WASHINGTON, DC, 20001, US

(73) Assignee: SAMSUNG ELECTRONICS CO., LTD, Suwon-City (KR)

(21) Appl. No.: 10/256,286

(22) Filed: Sep. 27, 2002

(30) Foreign Application Priority Data
Sep. 29, 2001 (KR) 2001-61040
Jan. 31, 2002 (KR) 2002-5650

(51) Int. Cl. H04N 5/781

(52) U.S. Cl. 386/95; 386/125

(57) ABSTRACT

An information storage medium on which a user-defined unified information file is recorded, and a recording method and apparatus therefor. The information storage medium includes: a plurality of data files, each with audio data and/or video data; a plurality of information files, each corresponding to a respective data file, and each with navigation information on a data file; a unified information file with management information of the information files; and a user-defined unified information file with navigation information for at least a portion of audio and/or video data, as selected by a user, among the data files. With an information storage medium of the present invention having this user-defined unified information file, a portion of audio and/or video data on the storage medium desired by the user can be reproduced in a desired order.

### CROSS-REFERENCE TO RELATED APPLICATIONS

This application claims the benefit of Korean Application Nos. 2001-61040, filed Sep. 29, 2001; and 2002-5650, filed Jan. 31, 2002 in the Korean Intellectual Property Office, the disclosures of which are incorporated herein by reference.

### BACKGROUND OF THE INVENTION

1. Field of the Invention

The present invention relates to a data structure of audio and/or video data (hereinafter referred to as “AV data”) which are recorded on an information storage medium, and more particularly, to an information storage medium on which AV data is recorded such that the AV data can be easily edited, and a method of recording the same.

2. Description of the Related Art

With an information storage medium on which a plurality of data files, having respective AV data, are recorded, a user may want to reproduce only desired portions of a data file or data files in a desired order, regardless of the recorded order of the data files.

### SUMMARY OF THE INVENTION

To solve the above problems, it is an object of the present invention to provide an information storage medium, on which a user-defined unified information file, having necessary information for reproducing only desired portions of a plurality of data files, is recorded, and a recording method therefor.

Additional objects and advantages of the invention will be set forth in part in the description which follows and, in part, will be obvious from the description, or may be learned by practice of the invention.

Another object of the present invention is to provide an information storage medium with recorded data having a structure in which, if at least a portion of a data file is edited or deleted, the edits or deletions are reflected by a user-defined unified information file, and a recording method therefor.

A further object of the present invention is to provide an information storage medium with recorded data having a structure in which, if at least a portion of a data file is edited or deleted, the edits or deletions are more easily reflected by a user-defined unified information file, and a recording method therefor.

To achieve the above and other objects, an embodiment of the present invention may provide an information storage medium, including: a plurality of data files, in each of which audio data and/or video data are recorded; a plurality of information files which are prepared to correspond to the respective data files, and in each of which navigation information on a data file is recorded; a unified information file in which management information on the information files are recorded; and a user-defined unified information file in which navigation information on at least a portion selected by a user among the data files is recorded.

The unified information file or the information file may include file link information indicating a linked user-defined unified information file. The file link information may include a link information table in which the number of linked user-defined unified information files and the identifiers of the linked user-defined unified information files are recorded.

The information file may include time information for reproducing a data file corresponding to the information file, and location information on a location in the data file corresponding to the time information, as navigation information. The time information may be expressed by a reproducing start time of each time unit when a time period from the reproducing start time to the reproducing end time of a data file, corresponding to the information file, is divided by a predetermined time unit.

The user-defined unified information file may include time information on a portion of the data file that a user desires to reproduce, and the identifier of an information file corresponding to the data file, as navigation information.

The unified information file may include identifiers of corresponding information files, and time information for reproducing corresponding data files as the management information. Regarding the management information, the time information may be expressed by the reproducing start time of a first time unit and the reproducing start time of a last time unit.

To achieve the above and other objects, an embodiment of the present invention may provide a recording method including: recording audio and/or video data as at least one data file; recording navigation information of each data file as at least one information file so that an information file corresponds to a data file; and recording management information on the information files as a unified information file.

Another recording method embodiment may further include: recording navigation information on at least a portion of data files selected by a user as a user-defined unified information file; and recording file link information indicating that the user-defined unified information file is linked into a corresponding unified information file.

Alternatively, a recording method embodiment may include : recording navigation information on a predetermined number of data files selected by a user as a user-defined unified information file; and recording file link information indicating that the user-defined unified information file is linked into a corresponding information file.

To achieve the above and other objects, an embodiment of the present invention may provide an apparatus including: a digital interface which receives audio and/or video data; a recording unit which records information on an information storage medium; and a control unit which controls the recording unit to record the audio and/or video data input through the digital interface as at least one data file, record navigation information of data files as at least one information file so that the an information file corresponds to a data file, and record management information on at least one information file as a unified information file.

The control unit may control the recording unit to record navigation information on at least a portion of a data file or data files selected by the user as a user-defined unified information file, and record file link information indicating that the user-defined unified information is linked into a corresponding unified information file. Alternatively, the control unit may control the recording unit to record navigation information on at least a portion of a data file or data files selected by the user as a user-defined unified information file, and record file link information indicating that the user-defined unified information is linked into a corresponding information file.

### BRIEF DESCRIPTION OF THE DRAWINGS

These and other objects and advantages of the present invention will become apparent and more readily appreciated from the following description of the preferred embodiments, taken in conjunction with the accompanying drawings of which:

FIG. 1 is a block diagram of a recording/reproducing apparatus according to an embodiment of the present invention;

FIG. 2 is a diagram of a structure of data which is recorded on an information storage medium according to an embodiment of the present invention;

FIG. 3 is a diagram of data structures of a data file, an information file, and a unified information file;

FIG. 4 is a diagram of data structures of an information file and a user-defined information file;

FIG. 5 is a diagram of the relationship between a user-defined unified information file and a data file according to an embodiment of the present invention;

FIG. 6 is a diagram of the relationship between a user-defined unified information file and a data file according to another embodiment of the present invention;

FIG. 7 is a partial detailed diagram of a unified information file;

FIG. 8 is a partial detailed diagram of an information file in which file link information is recorded;

FIG. 9 is a flowchart for explaining a recording method according to an embodiment of the present invention;

FIG. 10 is a flowchart for explaining a recording method according to another embodiment of the present invention;

FIG. 11 is a flowchart for explaining a recording method according to still another embodiment of the present invention; and

FIG. 12 is a flowchart for explaining a reproducing method according to an embodiment of the present invention.

### DETAILED DESCRIPTION OF THE PREFERRED EMBODIMENTS

Reference will now be made in detail to the present embodiments of the present invention, examples of which are illustrated in the accompanying drawings, wherein like reference numerals refer to the like elements throughout. The embodiments are described below in order to explain the present invention by referring to the figures.

Referring to FIG. 1, the recording apparatus has a recording/reading unit 1, a control unit 2, a decoding unit 3, an encoding unit 4, and a digital interface 5. Based on the control of the control unit 2, the recording/reading unit 1 reads AV data from or records AV data on a recordable disc 100, which is one of information storage media according to the present invention. According to the control of the control unit 2, the decoding unit 3 decodes AV data in a predetermined decoding method, and sends the decoded AV data to the digital interface 5. “Decoding” means at least a part of a variety of different level decodings, including channel demodulation, decoding for error correction, and decoding for restoring compressed data. According to the control of the control unit 2, the encoding unit 4 encodes the AV data input through the digital interface 5 in a predetermined encoding method, and sends the encoded data to the recording/reading unit 1. “Encoding” means at least a part of a variety of different level encodings, including encoding for error correction, and encoding for compressing data. According to the control of the control unit 2, the recording/reading unit 1 records data having a data structure according to the present invention on the recordable disc 100.

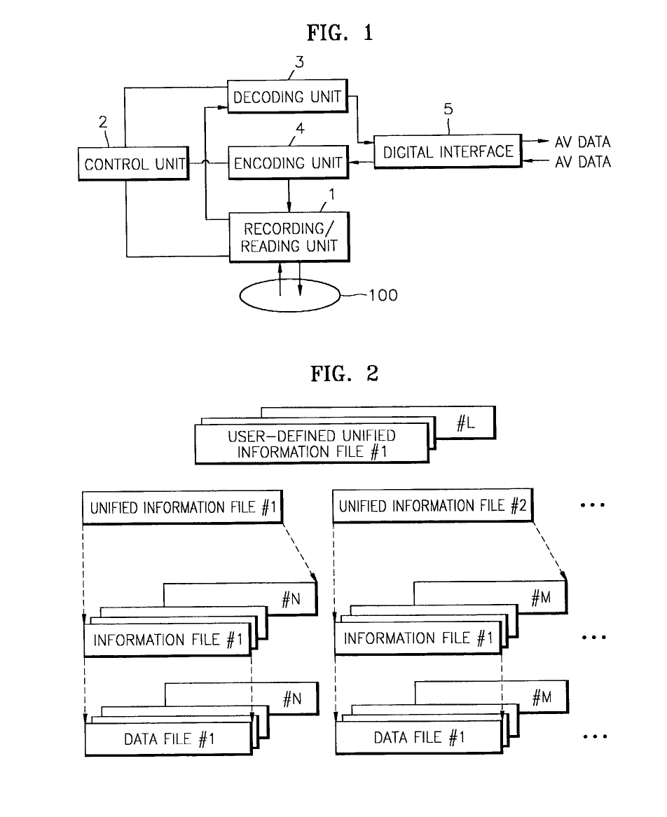

FIG. 2 is a diagram of a structure of data which is recorded on an information storage medium according to an embodiment of the present invention.

Referring to FIG. 2, a plurality of data files, a plurality of information files, each prepared to correspond to a data file, at least one unified information file prepared to correspond to a group of information files, and a user-defined unified information file are recorded on the information storage medium. Data files #1 through #N correspond to information files #1 through #N, respectively, and data files #1 through #M correspond to information files #1 through #M, respectively. Unified information file #1 corresponds to information files #1 through N, and unified information file #2 corresponds to information files #1 through M.

AV data is recorded in the data files, with navigation information of a data file corresponding to the information file being recorded on the information storage medium. Navigation information means information needed in searching for or reproducing a data file corresponding to the information file. In the present embodiment, the navigation information can include time information which is expressed by a predetermined time unit obtained by dividing a time period from start to end for reproducing a data file corresponding to an information file by the predetermined time unit, and location information having a location in the data file corresponding to respective time information.

The unified information file stores management information for managing an information file corresponding to a data file. In the present embodiment, the management information can include the identifier of a corresponding information file, and time information for reproducing a data file corresponding to the information file. Also, the unified information file stores link file information which indicates a linked user-defined unified information file. The link file information will be explained in detail below.

Navigation information on a portion of a data file which is desired to be reproduced by a user is recorded in the user-defined unified information file. In the present embodiment, the navigation information can include the identifier of an information file corresponding to a data file having a portion that is desired to be reproduced by the user, and time information on the portion that is desired to be reproduced by the user. Time information may be expressed in a variety of ways. When a time period from the start time and end time of reproducing a corresponding data file is divided by a predetermined time unit, time information may be expressed by the start time of the first time unit of the portion desired to be reproduced by the user, and the start time of the last time unit of the desired portion. Alternatively, time information may be expressed by the reproducing start time and an offset value from the reproducing start time to a reproducing end time of the portion desired to be reproduced by the user.

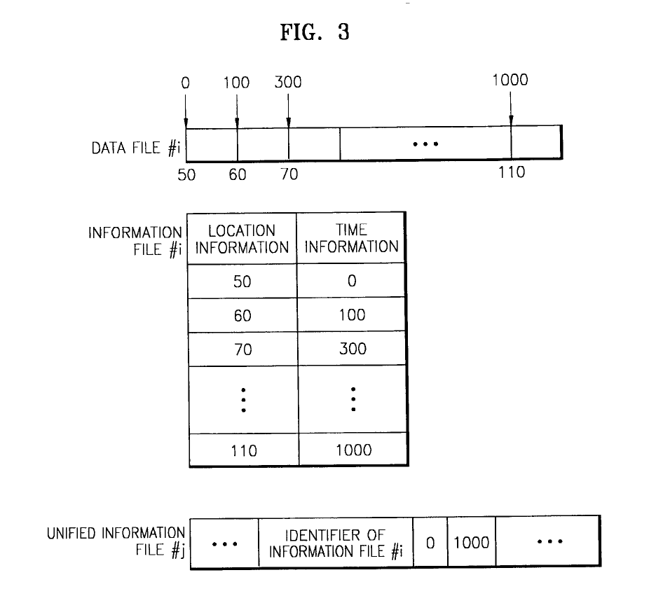

FIG. 3 is a diagram of data structures of a data file, an information file, and a unified information file according to an embodiment of the present invention.

Referring to FIG. 3, location information and time information of data file #i corresponding to the information file #i are recorded in information file #i. That is, it is shown that in data file #i, reproducing data in address 50 starts at time 0, and reproducing data in address 60 starts at time 100.

In unified information file #j, the identifier of information file #i managed by the unified information file #j is recorded, and as time information of information file #i, the reproducing start time of a first time unit and the reproducing start time of a last time unit, that is, 0 and 100, are recorded.

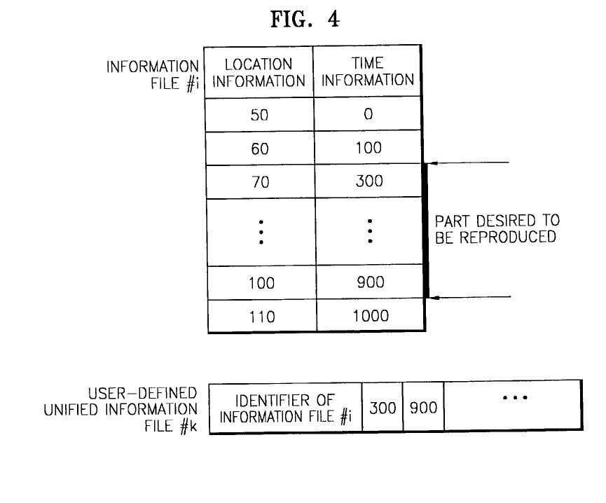

FIG. 4 is a diagram of data structures of an information file and a user-defined information file according to an embodiment of the present invention.

Referring to FIG. 4, if a user wants to reproduce only a portion of data file #i from address 70 to address 109, the identifier of information file #i corresponding to the data file #i is recorded in user-defined unified information file #k. The reproducing start time of a first time unit of the portion desired to be reproduced, and the reproducing start time of a last time unit of the portion, that is, 300 and 900, are also recorded in user-defined unified information file #k.

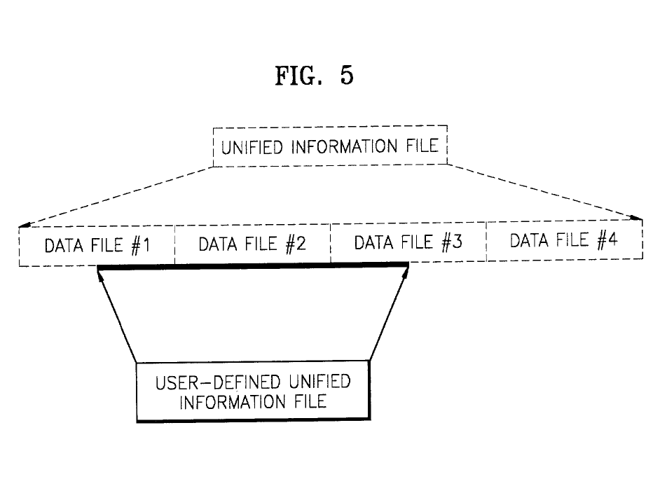

FIG. 5 is a diagram of a data structure showing the relationship between a user-defined unified information file and a data file according to another embodiment of the present invention.

Referring to FIG. 5, if the user wants to reproduce only a portion of a data file indicated by a thick solid line among data files #1 through #4 under management of a predetermined unified information file, the identifiers of data files to which the portion desired to be reproduced belongs, that is, data files #1 through #3, are recorded in a user-defined unified information file. Also, time information of a portion of data file #1 which belongs to the desired portion is recorded. Time information is obtained from information file #1 (not shown) corresponding to data file #1. Likewise, time information of portions of data files #2 and #3 that belong to the desired portion is also recorded. Time information is obtained from information files #2 and #3 (not shown) corresponding to data files #2 and #3.

For example, it is assumed that AV data containing club meetings is recorded as data files #1 through #4, data file #1 represents a spring meeting, data file #2 represents a summer meeting, data file #3 represents a fall meeting, and data file #4 represents a winter meeting. Then, while the user watches scenes displayed by reproducing data files #1 through #4, the user can select a portion of the scenes desired to be reproduced, by inputting a reproducing start time and a reproducing end time.

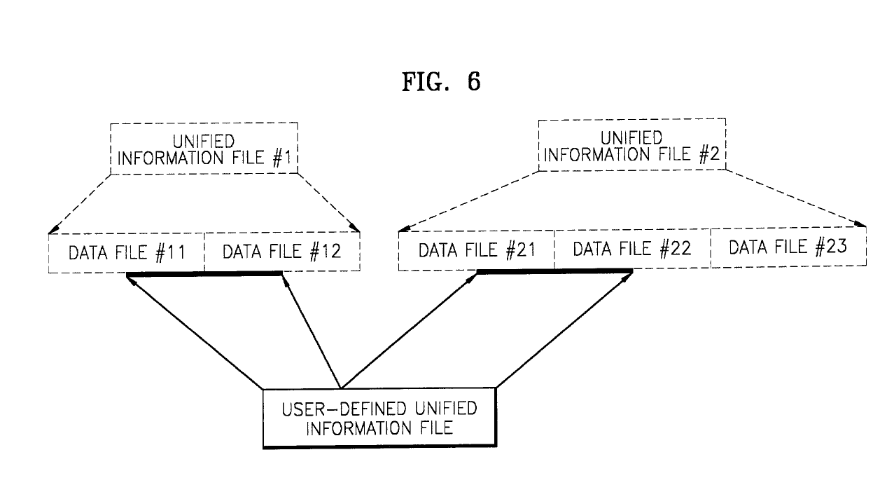

FIG. 6 is a diagram of the data structure showing the relationship between a user-defined unified information file and a data file according to another embodiment of the present invention.

Referring to FIG. 6, the user can select a portion which the user wants to reproduce, and is under management of different unified information files. That is, if the user wants to reproduce a portion, as indicated by a thick solid line among data files #11 and #12 under management of unified information file #1 and data files #21 through #23 under management of unified information file #2, the identifiers of data files belonging to the portion desired to be reproduced, that is, data files #11, #12, #21, and #22, are recorded in a corresponding user-defined unified information file. Also, time information on a portion of data file #11 belonging to the desired portion is recorded. Time information is obtained from information file #11 (not shown) corresponding to the data file. Likewise, time information of portions of data files #12, #21, and #22 that belong to the desired portion are also recorded. Time information is obtained from information files #12, #21, and #22 (not shown) corresponding to data files #12, #21, and #22, respectively.

For example, if unified information file #1 manages data files #11 and #12 containing recorded club meetings, and unified information file #2 manages data files #21 through #23 containing recorded club picnics, the user may want to reproduce a portion of the files in which a predetermined person appears, among data files #11 through #23. That is, while the user watches scenes displayed by reproducing data files #11 through #23, the user can select a portion which is desired to be reproduced, by inputting a reproducing start time and a reproducing end time.

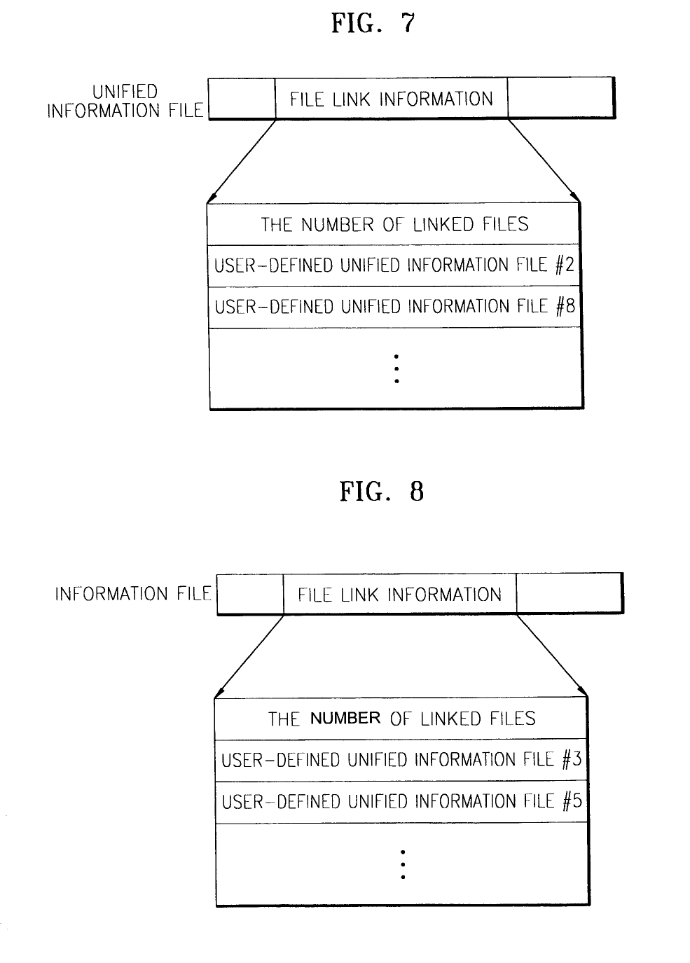

FIG. 7 is a partial detailed diagram of a unified information file of an embodiment of the present invention.

Referring to FIG. 7, file link information which indicates a user-defined unified information file linked to the unified information file is recorded in the unified information file. “File link information” means information needed for finding the corresponding user-defined unified information file. In the present embodiment, the file link information is implemented as a link table. The number of linked user-defined unified information files, and the identifiers of the linked user-defined unified information files are recorded in the link table.

The fact that a user-defined unified information file is linked to a unified information file indicates that a data file corresponding to an information file managed by the unified information file belongs to a data file or data files portion which is desired to be reproduced by the user. Accordingly, if a predetermined data file managed by the unified information file is edited or deleted, management information recorded in the unified information file can be modified to reflect this condition. Also, after opening a linked user-defined unified information file, navigation information recorded in the file can be easily modified. Though not linked to a unified information file, a user-defined unified information has the identifier of the data file, or an information file corresponding to the data file, and therefore, by checking all user-defined unified information files, related navigation information can be modified. However, as the number of user-defined unified information files increases, the time for checking the contents of user-defined unified information files increases such that the efficiency is degraded. That is, by recording file link information in a unified information file, files recorded on the information storage medium can be managed more efficiently.

Instead of recording file link information, which indicates linked user-defined unified information files, in a unified information file, file link information may be recorded in an information file alternatively.

FIG. 8 is a partial detailed diagram of an information file in which file link information is recorded in another embodiment of the present invention.

Referring to FIG. 8, file link information indicating a linked user-defined unified information file is recorded in an information file. “File link information” is information needed for finding a user-defined unified information file corresponding to the information file. In the present embodiment, file link information is implemented as a link table. The number of linked user-defined unified information files, and the identifiers of the linked user-defined unified information files are recorded in the link table.

As in FIG. 7, the fact that a user-defined unified information file is linked to an information file indicates that a data file corresponding to the information file belongs to a portion of a data file which is desired to be reproduced by the user. Accordingly, if a data file corresponding to the information file is edited or deleted, management information recorded in the information file and the unified information file can be modified to reflect this condition. Also, after opening a user-defined unified information file linked to the information file, navigation information recorded in the file can be easily modified. In particular, when editing is performed that has no relationship to the reproducing start time and reproducing end time of the data file, that is, when a portion in the middle of the data file, not the start or end portion of the data file, is edited or deleted, the user-defined unified information file mentioning the corresponding data file can be found and the contents of the corresponding user-defined unified information file can be modified by referring to the information file corresponding to the data file without having to open the unified information file corresponding to the data file.

Though not linked to an information file, a user-defined unified information has the identifier of the data file, or an information file corresponding to the data file, and therefore, by checking all user-defined unified information files, related navigation information can be modified. However, as the number of user-defined unified information files increases, the time for checking the contents of user-defined unified information files increases, thereby resulting in an overall efficiency becoming degraded. That is, by recording file link information in an information file, files recorded on the information storage medium can be managed more efficiently.

A recording method according to embodiments of the present invention having structures described above will now be explained.

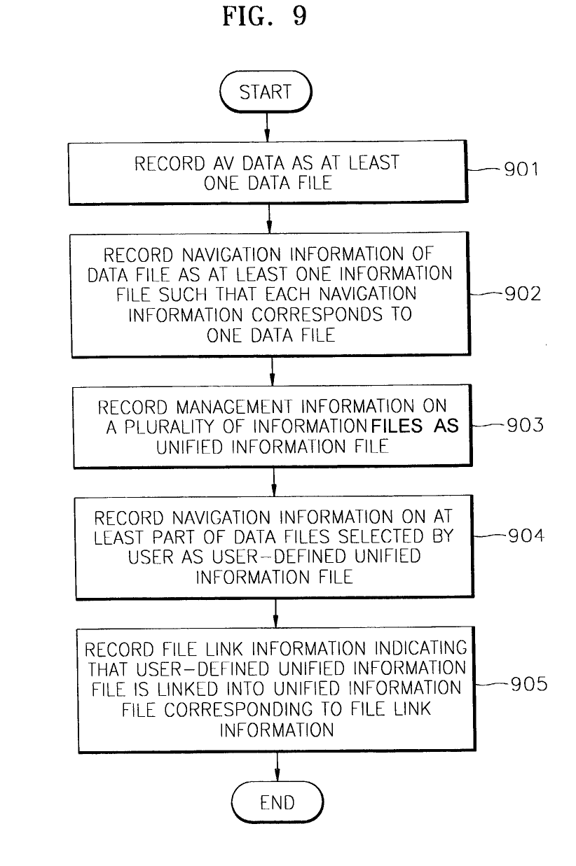

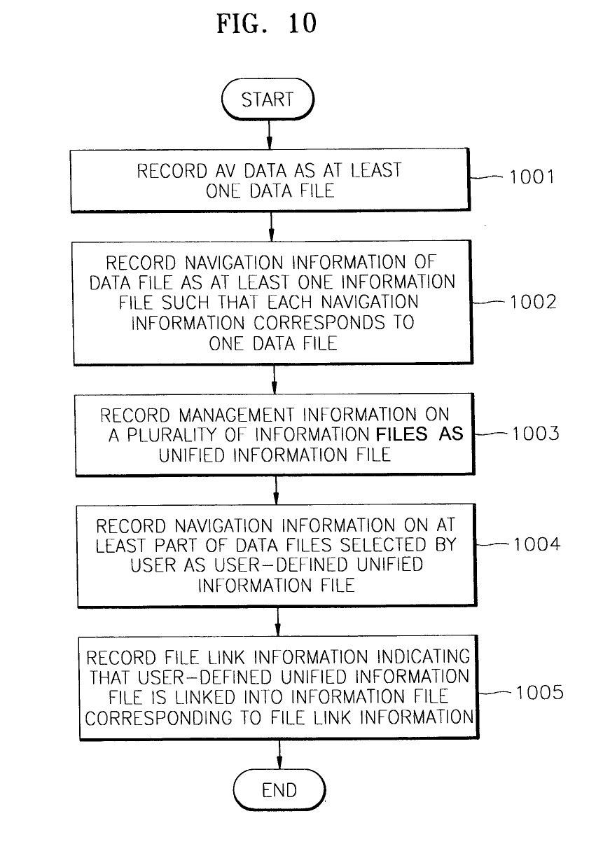

FIG. 9 is a flowchart for explaining a recording method according to an embodiment of the present invention.

Referring to FIG. 9, a recording apparatus records AV data being input as at least one data file in an information storage medium, in operation 901, and records navigation information as at least one information file so that each information file corresponds to one data file, in operation 902. Also, management information on a plurality of information files are recorded as a unified information file, in operation 903.

Meanwhile, if the user wants to reproduce a predetermined portion of a data file and to store the portion separately, the user selects the portion desired to be reproduced, the recording apparatus generates a user-defined unified information file, and then records navigation information on at least some data files selected by the user in the user-defined unified information file, in operation 904. Time information for reproducing the portion selected by the user, and the identifier of an information file corresponding to the portion may be recorded as navigation information. When a time period from the reproducing start time to the reproducing end time of the corresponding data file is divided by a predetermined time unit, the reproducing start time of a first time unit, and the reproducing start time of a last time unit may be recorded as time information.

Also, when the user-defined unified information file is generated, the recording apparatus records file link information indicating that the user-defined unified information file is linked to a corresponding unified information file, in operation 905. The file link information may be recorded as a link information table containing the number of linked user-defined unified information files, and their identifiers.

FIG. 10 is a flowchart for explaining a recording method according to another embodiment of the present invention.

Referring to FIG. 10, a recording apparatus records AV data being input as at least one data file in an information storage medium, in operation 1001, and records navigation information as at least one information file so that each information file corresponds to one data file, in operation 1002. Also, management information on a plurality of information files are recorded as a unified information file, in operation 1003.

Meanwhile, if the user wants to reproduce a predetermined portion of a data file and to store that portion separately, the user selects the portion desired to be reproduced, the recording apparatus generates a user-defined unified information file, and then records navigation information on at least some of the data files selected by the user in the user-defined unified information file, in operation 1004. Time information for reproducing the portion selected by the user, and the identifier of an information file corresponding to the portion may be recorded as navigation information. When a time period from the reproducing start time to reproducing end time of the corresponding data file is divided by a predetermined time unit, the reproducing start time of a first time unit, and the reproducing start time of a last time unit may be recorded as time information.

Also, when the user-defined unified information file is generated, the recording apparatus records file link information, indicating that the user-defined unified information file is linked, into a corresponding information file, in operation 1005. The file link information may be recorded as a link information table containing the number of linked user-defined unified information files, and their identifiers.

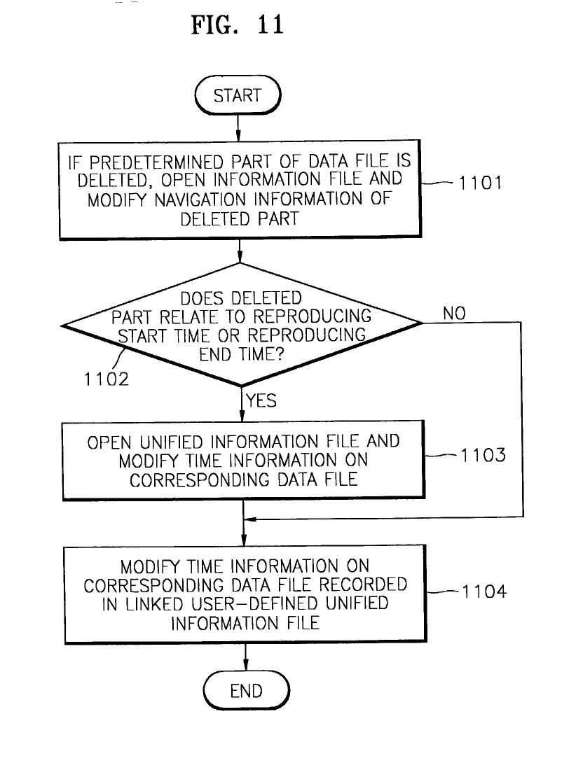

FIG. 11 is a flowchart for explaining a recording method according to still another embodiment of the present invention.

Referring to FIG. 11, when a predetermined portion of a data file is deleted, the recording apparatus opens an information file and modifies navigation information on the deleted portion, in operation 1101.

When the deleted portion includes the start portion or the end portion of the data file, that is, the deleted portion relates to the reproducing start time and reproducing end time of the data file in step 1102, the recording apparatus opens a unified information file and modifies time information on the data file, in operation 1103. When file link information is recorded in the unified information file, the recording apparatus finds a linked user-defined unified information file by referring to the file link information recorded in the unified information file, and modifies time information on the data file recorded in the user-defined unified information file, in operation 1104.

If the deleted portion is a middle portion, not the start or the end portion of the data file, that is, the deleted portion does not relate to the reproducing start time and reproducing end time of the data file in operation 1102, and if file link information is recorded in the information file, the recording apparatus does not need to open the unified information file, and can find a linked user-defined unified information file and modify time information on the data file recorded in the user-defined unified information file by referring to file link information recorded in the information file, in operation 1104.

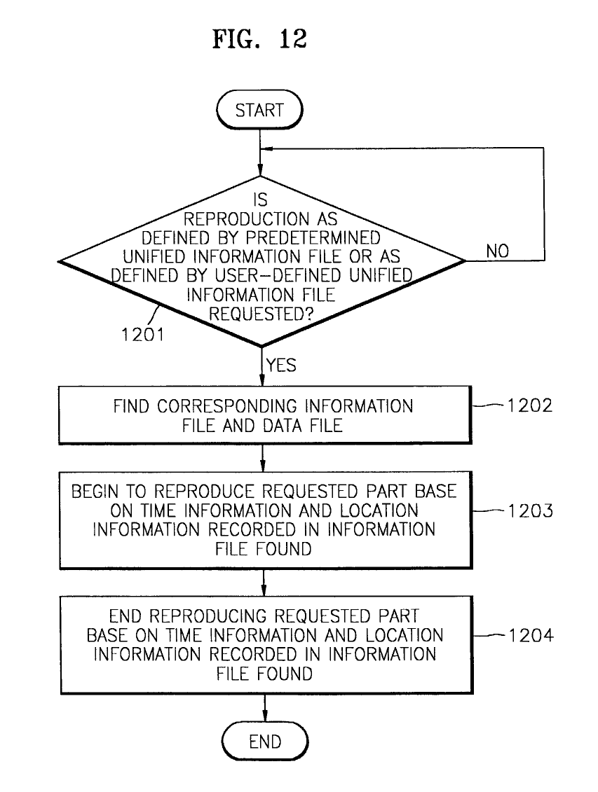

FIG. 12 is a flowchart for explaining a reproducing method according to an embodiment of the present invention.

Referring to FIG. 12, if the user requests to reproduce data as defined in a predetermined unified information file or a user-defined unified information file, the recording apparatus finds an information file and a data file, by referring to management information or navigation information recorded in the unified information file or the user-defined unified information file, in operation 1201. Using time information and location information recorded in the found information file, the recording apparatus finds the location of a portion of a data file or data files requested to be reproduced by the user, and starts reproducing data from the found location, in operation 1202. The end time is found in the same manner, and the reproduction ends at the end location, in operation 1203.

As described above, according to the present invention, with a user-defined unified information file, a portion of AV data, as desired by the user, can be reproduced in a desired order. Also, by recording file link information indicating a user-defined unified information file linked to an information file or a unified information file, editing or deleting a data file can be easily reflected by a related user-defined unified information file.

Although a few preferred embodiments of the present invention have been shown and described, it would be appreciated by those skilled in the art that changes may be made in this embodiment without departing from the principles and spirit of the invention, the scope of which is defined in the claims and their equivalents.

What is claimed is:

1. A storage medium, comprising:
a plurality of data files, with audio data and/or video data being recorded in each data file;
a plurality of information files, each being prepared to correspond to a respective data file, with navigation information for the respective data file being recorded in each respective information file;
a unified information file with management information for the information files; and
a user-defined unified information file with navigation information for at least a portion of audio and/or video data selected by a user among the data files.

2. The storage medium of claim 1, wherein file link information indicating a linked user-defined unified information file is recorded in the unified information file.

3. The storage medium of claim 1, wherein file link information indicating a linked user-defined unified information file is recorded in the information file.

4. The storage medium of claim 3, wherein the file link information includes a link information table including a number of linked user-defined unified information files and identifiers of the linked user-defined unified information files.

5. The storage medium of claim 1, wherein a first information file includes time information for reproducing a first data file corresponding to the first information file, and location information of a location in the first data file corresponding to the time information, as navigation information.

6. The storage medium of claim 5, wherein when a time period from a reproducing start time to a reproducing end time of the first data file corresponding to the first information file is divided by predetermined time units, the time information is expressed by the reproducing start time of each time unit.

7. The storage medium of claim 1, wherein the user-defined unified information file includes time information on a portion of audio and/or video data of a first data file that a user desires to reproduce, and an identifier of a first information file corresponding to the first data file, as navigation information.

8. The storage medium of claim 1, wherein the unified information file includes identifiers of first information files, and time information for reproducing data files corresponding to the first information files as the management information.

9. The storage medium of claim 8, wherein when a time period from a reproducing start time and a reproducing end time of a first one of the data files is divided by predetermined time units, a first time information is expressed by the reproducing start time, being a first time unit of the first data file, and a reproducing start time of a last time unit of the first data file is recorded as management information.

10. A recording method, comprising:
recording audio and/or video data in at least one data file of a plurality of data files;
recording navigation information of each data file in a corresponding information file; and
recording management information of each information file in a unified information file.

11. The recording method of claim 10, further comprising:
recording navigation information of at least a portion of audio and/or video data of the plurality of data files as selected by a user, in a user-defined unified information file; and
recording file link information indicating that the user-defined unified information file is linked to a corresponding unified information file.

12. The recording method of claim 11, wherein the recording of navigation information of the at least a portion of audio and/or video data further comprises recording time information for reproducing the portion selected by the user and an identifier of the information file corresponding to the portion selected, in the user-defined unified information file.

13. The recording method of claim 12, wherein the recording of the time information further comprises, when a time period from a reproducing start time to a reproducing end time of one data file is divided by a predetermined time unit, recording the reproducing start time, being a first time unit of the one data file, and a reproducing start time of a last time unit of the data file, as the time information.

14. The recording method of claim 11, wherein the recording file link information further comprises recording a link information table containing a number of linked user-defined unified information files and identifiers of the linked user-defined unified information files as the file link information.

15. The recording method of claim 10, further comprising:
recording navigation information on a predetermined number of the data files, as selected by a user, as a user-defined unified information file; and
recording file link information indicating that the user-defined unified information file is linked to a corresponding one of the information files.

16. The recording method of claim 15, wherein the recording file link information further comprises recording a link information table containing a number of linked user-defined unified information files and identifiers of the linked user-defined unified information files as the file link information.

17. The recording method of claim 10, further comprising, when a portion of one of the data files is deleted, the navigation information in a corresponding one of the information files is modified.

18. The recording method of claim 17, wherein when the deleted portion includes a start portion or the end portion of the data file, time information in the unified information file is modified.

19. The recording method of claim 15, wherein, when a portion of one of the data files is deleted, and when the deleted portion includes a start portion or the end portion of the data file, time information in a user unified information file and the navigation information in a corresponding one of the information files are modified.

20. An apparatus, comprising:
a digital interface to receive audio and/or video data;
a recording unit to record information on an information storage medium; and
a control unit to control the recording unit to record the audio and/or video data input through the digital interface as at least one data file of a plurality of data files, record navigation information of each data file in a corresponding information file, and record management information of at least one of the information files as a unified information file.

21. The apparatus of claim 20, wherein the control unit controls the recording unit to record navigation information of at least a portion of audio and/or video data of the at least one data file, as selected by the user, in a user-defined unified information file, and record file link information indicating that the user-defined unified information is linked to the unified information file.

22. The apparatus of claim 20, wherein the control unit controls the recording unit to record navigation information on at least a portion of audio and/or video data of the at least one data file, as selected by the user, in a user-defined unified information file, and record file link information indicating that the user-defined unified information is linked to the information file.

23. An apparatus, comprising:
a reproducing unit to read data from an information storage medium;
a digital interface to decode and output audio and/or video data read by the reproducing unit based on recorded data on the information storage medium, including a plurality of AV data files, an information file for each AV data file, with each information file including navigation information for each corresponding AV data file, a unified information file having management information for a plurality of information files, and a user-defined unified information file with navigation information for at least a portion of audio and/or video data selected by a user among audio and/or video data stored in at least one of the AV data files.

24. The apparatus of claim 23, wherein the navigation information for the portion of audio and/or video data is stored in a user-defined unified information file on the information storage medium with file link information indicating that the user-defined unified information is linked to the unified information file.

25. The apparatus of claim 23, wherein the navigation information for the portion of audio and/or video data is stored in a user-defined unified information file on the information storage medium with file link information indicating that the user-defined unified information is linked to a corresponding one of the information files.
